(19) United States
(12) Patent Application Publication
(10) Pub. No.: US 2025/0117569 A1
(43) Pub. Date: Apr. 10, 2025

(54) NON-LINEAR TEXT SCALING

(71) Applicant: GOOGLE LLC, Mountain View, CA (US)

(72) Inventor: Mark Arthur Schillaci, San Jose, CA (US)

(21) Appl. No.: 18/482,169

(22) Filed: Oct. 6, 2023

(51) Int. Cl. G06F 40/109; G06F 3/04847

(52) U.S. Cl. CPC G06F 40/109; G06F 3/04847; G06F 2203/04806

(57) ABSTRACT

Disclosed implementations allow for the customization of text size in displayable content via a nonlinear text scaling, which provides users with enhanced readability and accessibility options. Nonlinear text scaling includes adjusting the text size of displayable content using a fixed font size, a zoom level, and a uniformity level. User interface elements can be provided that allow manipulation of the zoom level and the uniformity level. User interface elements can be provided that add bolding and word/line/character spacing.

### BACKGROUND

Text in an application window can be scaled to help with readability. Low-vision users scale content by increasing the zoom level. Scaling the content includes multiplying each font size by a zoom factor, which is a decimal representation of the zoom level. The zoom level can range between 50% and 300%.

### SUMMARY

Implementations relate to providing the ability to scale text in a non-linear manner. In particular, implementations relate to using a uniformity level and a fixed font size in addition to a zoom factor to adjust the size at which text is displayed. The uniformity level controls the contrast between different font sizes used in the content and the fixed font size. More specifically, in disclosed implementations, the fixed font size scales linearly with the zoom level regardless of contrast (uniformity level), and the uniformity level controls how fast fonts larger than and smaller than the fixed font size scale in relation to the fixed font size. For example, at high contrast (represented by a low uniformity level) the scaling approaches linear scaling for all font sizes. As the contrast decreases (represented by an increasing uniformity level), larger fonts will scale more slowly as the zoom level increases from 100%; put another way, the larger the difference in size between the larger font and the fixed font size, the more slowly the larger font scales. Likewise, as the zoom level decreases from 100% (shrinking text), and as the contrast decreases (the uniformity level increases) the smaller fonts will scale down more slowly in relation to the fixed font size.

Implementations include a user interface control that enables a user to adjust the contrast, e.g., from a minimum uniformity level that represents highest contrast, to a high uniformity level representing lowest contrast. This user interface control may be presented with a conventional zoom control. Conventional zoom controls can represent a page setting, e.g., applying to text currently displayed in a particular application window/tab. Conventional zoom controls can represent an application setting, e.g., applying to content in any window or tab for the application. Some implementations may have a system setting, e.g., where the zoom level and/or uniformity level are applied to all applications executing on a computing device, e.g., where the operating system enables text scaling. Uniformity levels can be applied in a hierarchy, e.g., with page settings trumping application settings and application settings trumping system settings. Some implementations may include a reset control. The reset control can set the uniformity level and/or zoom level back to a default level.

### BRIEF DESCRIPTION OF THE DRAWINGS

FIG. 1A is a diagram that illustrates text in an application window and a scaling user interface that includes a user interface element for selecting a uniformity level, according to an implementation.

FIG. 1B is a diagram that illustrates text in an application window and a scaling user interface that includes a reset control and a user interface element for selecting a uniformity level, according to an implementation.

FIG. 2A illustrates the application window of FIG. 1A at a zoom level of 200% and high contrast (minimum uniformity level), according to an implementation.

FIG. 2B illustrates the application window of FIG. 1A at a zoom level of 200% and a mid-range uniformity level, according to an implementation.

FIG. 2C illustrates the application window of FIG. 1A at a zoom level of 200% and low contrast (maximum uniformity level), according to an implementation.

FIGS. 3A and 3B illustrate an example user interface for setting a uniformity level that applies to a system or to an application, according to an implementation.

FIG. 4 is a diagram that illustrates a computing system for implementing the concepts described herein.

FIG. 5 is a flowchart illustrating an example process for non-linear scaling of text, according to an implementation.

### DETAILED DESCRIPTION

Implementations relate to non-linear scaling of fonts for text in displayable content. Specifically, linear scaling results in all text on a page scaling at the same rate, e.g., at a rate based on the zoom level. But because linear scaling affects increases the size of all font sizes on a page, linear scaling may impact the lead leads to a decrease in information density on the display at certain zoom levels, making viewing difficult for low vision users and potentially breaking the layout of the displayed content. These problems are especially apparent for computing devices with limited display area, such as smart phones, wearables (e.g., goggles, AR/VR glasses, smart watches, etc.), digital assistants with a display, etc. Thus, a technical problem with linear scaling is a change in the decrease in information density that conflicts with limited display area, which causes an increase in user interactions with the content (e.g., the low information density means the user must increase scrolling activity), which decreases useability for low-vision users and increases battery consumption.

Implementations provide a technical solution to these technical problems by providing a non-linear scaling method that uses a variable multiplier to scale displayable content. The variable multiplier is referred to as a uniformity level. The uniformity level controls a level of contrast between a fixed font size that scales linearly with the zoom level and other font sizes. Implementations include a user interface element for controlling the variable multiplier (the uniformity level) that can be included in a scaling interface. A scaling interface is a user interface that enables a user to adjust a zoom level and/or the uniformity level. Enabling users to control the uniformity level enables users to strike a balance between information density and zoom level for displayed content, increasing useability of and accessibility to the displayable content. Implementations may also include a reset control in the scaling interface that can set the zoom level and/or the uniformity level back to respective default values. The reset control and the uniformity levels can be applied at different hierarchies, e.g., a page level (page setting), an application level (application setting), a domain level (domain setting), and/or a system level (system setting). Implementations may also include other features to increase readability of the scaled content, such as adding a visual difference (e.g., adding bolding) to fonts that meet bolding criteria. Because non-linear scaling with low contrast and high zoom levels can result in much larger fonts appearing close to the same size as the normal font (e.g., the fixed font size), some implementations may add the visual difference to help differentiate, for example, a title or heading from normal text.

The implementations described herein enable improved guided human-machine interactions for scaling text to aid low-vision users and for selecting an optimal information density for such users. The addition of a uniformity level to control contrast, and thus information density, within a non-linear zoom operation for displayed content results in a reduction of scrolling interactions of the user interface when viewing content.

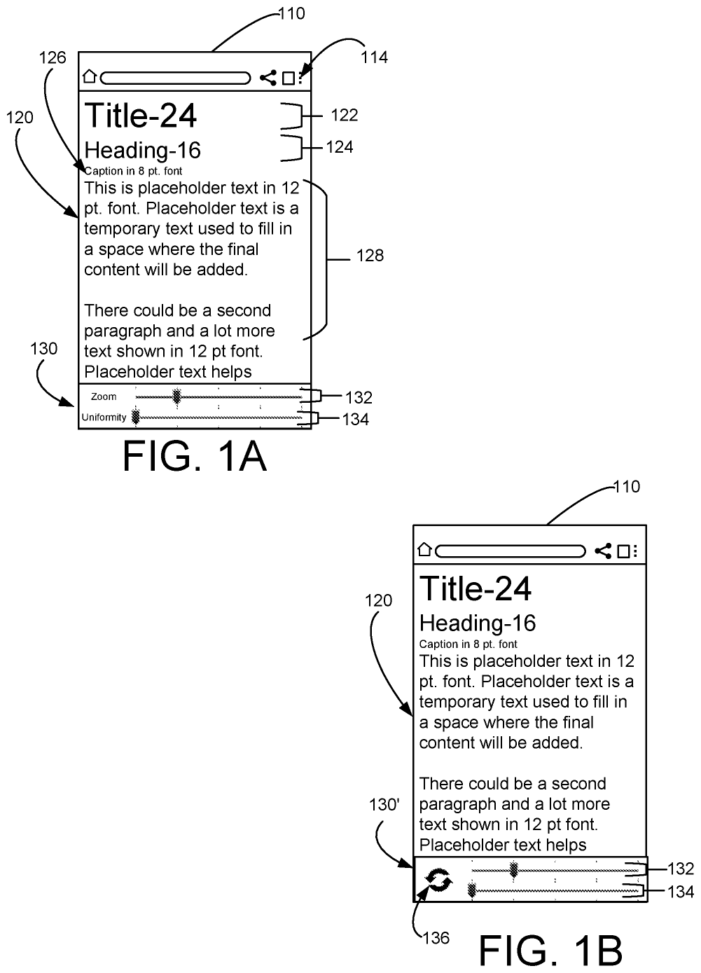

FIG. 1A is a diagram that illustrates displayable content in an application window 120 and a scaling user interface 130 that includes a contrast control 134 for selecting a uniformity level, according to an implementation. In the example of FIG. 1A, the application window 120 is a browser window, specifically a tab in a browser window, but the scaling user interface 130 and non-linear scaling described herein is applicable to other applications. Moreover, while the application window 120 of FIG. 1A is an example of an application window 120 on a device 110 with a limited display area, implementations are not limited to devices with a limited display area and device 110 could be another type of computing device, such as a laptop computer, a desktop computer, a tablet, a smart TV, an AR/VR device, a smart watch, or any other computing device that allows scaling of displayable content. Additionally, although many of the implementations shown and described herein are shown in portrait mode, any of the implementations described herein can be rendered in a landscape mode.

The application window 120 includes displayable content. Displayable content can be text-based. Text-based content includes characters, numbers, emojis, letters, etc. Text-based content can be any content that is assigned a font size, or in other words has a font size attribute. Displayable content can include non-text-based content, such as images or icons. Non-text-based content can be associated with a dimension attribute, e.g., a height and width. In the example of FIG. 1A, the displayable content includes title text 122, heading text 124, caption text 126, and normal text 128. In the example of FIG. 1A, the title text 122 has a 24-pt. font size, the text 124 has a 16-pt. font size, the caption text 126 has an 8-pt. font size, and the normal text 128 has a 12-pt. font size. The application window 120 may include additional displayable content not illustrated in FIG. 1A, e.g., additional text that will be displayed when the user performs a scrolling operation. The font sizes associated with the displayable content illustrated in the application window 120 are assigned by the content provider. For example, in FIG. 1A the application may be a browser tab displaying a web page and the font sizes of text in the web page are determined by the web page provider, e.g., using known markup language techniques such as stylesheets and/or HTML markup. Similarly, in a word processing application, font size is determined by the author of the document, etc. The font size set by the author/content provider is referred to as the default font size. The default font size, or initial font size, is the font size displayed without any scaling, or in other words without any zoom level applied.

FIG. 1A also includes a scaling user interface 130. Although illustrated as an overlay window in FIG. 1A, the scaling user interface 130 can be a floating window and need not be rectangular. Moreover, although illustrated at the bottom of the display, the scaling user interface 130 can be placed at the top or at either side of the display. The scaling user interface 130 may be surfaced via a user command. The user command used to surface the scaling user interface 130 can be a predetermined gesture, an assigned hardware control (button/slider), a menu option, etc. For example, a user may surface the scaling user interface 130 in response to a menu option available after selecting the menu icon 114. The scaling user interface 130 may include a zoom level control 132. The zoom level control 132 enables a user to enter a value within a range of values for the zoom level. A typical range for a device with limited display area, such as device 110, may have a start (minimum) value of 50% and an end (maximum) value of 200% or 250%. Other devices, such as laptops or tablets may have a higher end range value for the zoom level. While illustrated as a slider in FIG. 1A, the zoom level control 132 can take other forms, such as a text entry box (where the user enters a number), a drop-down menu, a plus/minus control where the user can adjust the zoom level by repeatedly selecting (clicking/touching) a plus or minus to adjust the zoom level up or down respectively, etc., or a combination of these. Thus, the zoom level control 132 can be any user interface element used to obtain a zoom level within a range of values.

The zoom level selected by the user, e.g., using zoom level control 132, is converted to a zoom factor. The zoom factor is a decimal representation of the zoom level. Because a zoom level of 100% represents no scaling (e.g., it is the default font size), the zoom factor is one (1) for a zoom level of 100%. A zoom level of 50% has a zoom factor of 0.5, a zoom level of 150% has a zoom factor of 1.5, etc. In a system with linear scaling, the font size is multiplied by the zoom factor (or a zoom scalar, as described herein); thus 12-pt. font becomes 18-pt. font at a zoom level of 150% and 24-pt. font at a zoom level of 200%, etc. Systems with linear scaling provide only a zoom level control 132 in the scaling user interface 130.

As illustrated in FIG. 1A, the scaling user interface 130 of disclosed implementations can also include a contrast control 134. The contrast control 134 enables a user to enter a value within a range of values for a uniformity level. The uniformity level is a variable used in non-linear scaling that controls a decay rate. The decay rate represents a smooth exponential decay that controls how quickly fonts larger than and smaller than the fixed font size scale in relation to the fixed font size. When the uniformity level is at the maximum range value, the bigger the size difference between a particular font size and the fixed font size, the slower the text in that particular font size will scale (e.g., large changes in the zoom level will not result in large changes to the font size). Font that is of the fixed font size will scale linearly with the zoom level, regardless of uniformity level (i.e., for all uniformity levels). The contrast control 134 is not present in systems with linear scaling because linear scaling does not include a decay variable. As with the zoom level control 132, the contrast control 134, although represented as a slider control in FIG. 1A, can be any control used to set the uniformity level to a value within a range of values.

The uniformity level may vary from a minimum (range start) value to a maximum (range end) value. The maximum value can approach infinity. In some implementations, the range end value for the uniformity level can be set at 100 where the maximum zoom level is 200% to 300%. Where the system includes a higher maximum zoom level, the range end value for the uniformity level can be set higher than 100. The range end value can thus be dependent on the range end value for the zoom level. An appropriate maximum value can be determined using the formula disclosed herein.

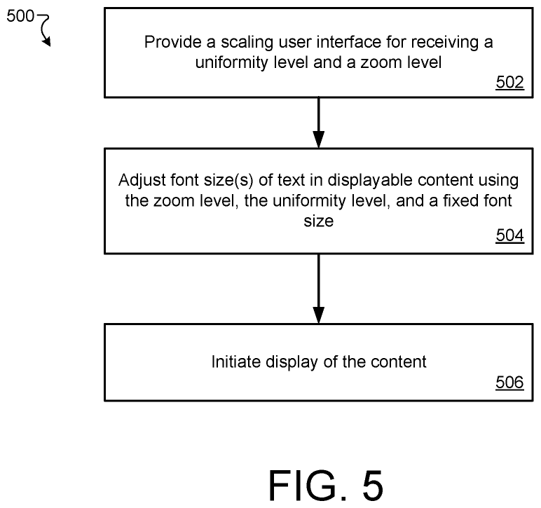

The minimum value (range start value) for the uniformity level should be a value that ensures that a first text (text 1) with a font size larger than the font size for a second text (text 2) does not become smaller than the second text. Put another way, the minimum value should ensure that text with a default font size of 32-pt. does not scale to a size smaller than text with a default font size of 16-pt. when that text occurs in the same displayable content (e.g., on the same web page). Put another way, the minimum value of the uniformity level should ensure that the non-linear function used to scale the displayable content does not go negative for any zoom levels and any fixed font size, and that the first derivative of the function over font size does not go negative for any font size at any fixed zoom level. The assignment of a minimum value (range start value) for the uniformity level can thus be dependent on zoom level or the fixed font size, as discussed in more detail with respect to FIG. 5.

In the example of FIG. 1A, the uniformity level is set to the range start value, which means that there is high contrast and the non-linear scaling will closely mirror linear scaling. Specifically, in the example of FIG. 1A, the zoom level of the zoom level control 132 is set at 100% and the uniformity level of the contrast control 134 is set to the minimum value, so the displayable content in the application window 120 is not scaled. Put another way, the displayable content in the application window 120 is displayed with their default (initial) font values.

FIG. 1B is a diagram that illustrates the application window 120 of FIG. 1A and a scaling user interface 130′ that includes a reset control 136 in addition to the contrast control 134 and the zoom level control 132, according to an implementation. The scaling user interface 130′ may include the reset control 136 to enable the user to reset the values of the uniformity level and the zoom level to default values. For example, the reset control 136 may be configured to reset the uniformity level to the range start value (the minimum value) and the zoom level to 100%. In the example of FIGS. 1A and 1B, the fixed font size is 12-pt.

In some implementations, the scaling user interface 130 of FIG. 1A and scaling user interface 130′ of FIG. 1B may be an example of a page-level scaling interface, e.g., for providing a page setting. In other words, the zoom level and the uniformity level set by the zoom level control 132 and contrast control 134 may be applied to the displayable content in the current window/page/tab, e.g., the browser tab of the application window 120, but not applied to other pages/tabs/windows for the application. As used herein page-level or page settings refer to zoom level and uniformity level settings for a window, page, or tab (depending on the type of application). In some implementations, the scaling user interface 130 of FIG. 1A and scaling user interface 130′ of FIG. 1B may be an example of an application-level scaling interface. In such an implementation, the zoom level and the uniformity level set by the zoom level control 132 and contrast control 134 may be applied to the displayable content in any window or tab of the application. Although shown with both a zoom level control 132 and a contrast control 134, in some implementations, the scaling user interface 130 or scaling user interface 130′ may include only one of the zoom level control 132 or the contrast control 134. For example, where the scaling user interface 130 is a page-level user interface, the uniformity level may be a system-level setting or an application-level setting and the contrast control 134 would not appear in the scaling user interface 130 or 130′. In some implementations, the zoom level may be the system level setting and the zoom level control 132 may not be included in the scaling user interface 130 or 130′. The reset control 136, if present, applies to the level applicable to the scaling user interface 130′. Thus, for example, if the scaling user interface 130′ lacks the contrast control 134 because the uniformity level is a system setting, selection of the reset control 136 may only adjust the zoom level to the default level.

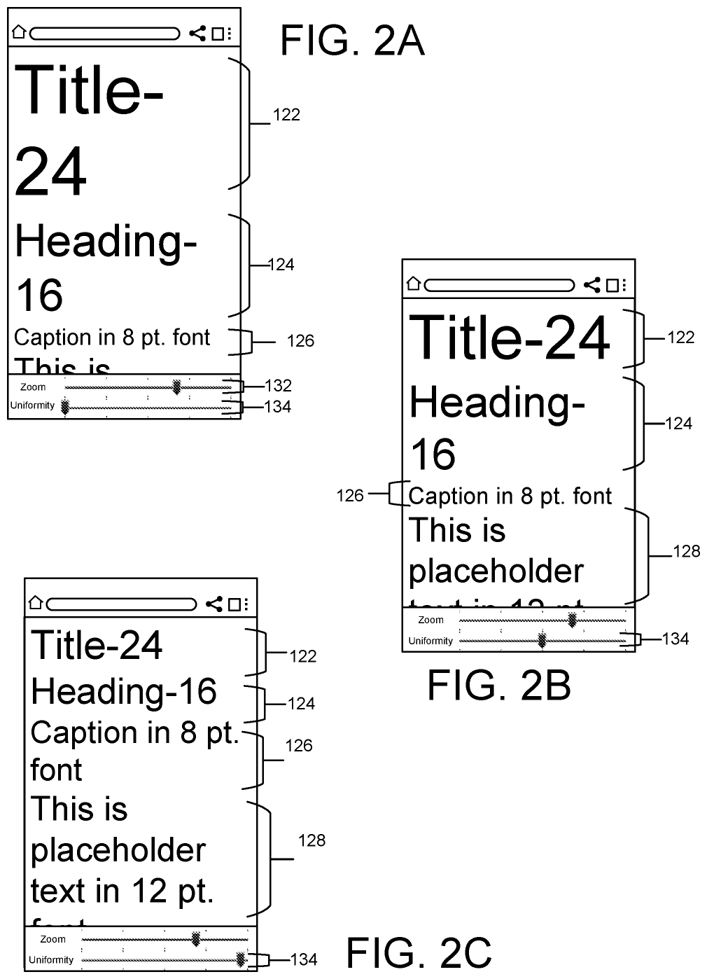

FIG. 2A illustrates the application window 120 of FIG. 1A at a zoom level of 200% and a minimum uniformity level (high contrast), according to an implementation. Thus, for example, FIG. 2A illustrates the displayable content of application window 120 of FIG. 1A in response to the user setting the zoom level to 200%, e.g., by interacting with the zoom level control 132. Because the uniformity level is low (the minimum value) in FIG. 2A, the displayable content of the application window 120 scales close to linearly. Thus, the title text 122 is illustrated in 48-pt. font, the text 124 is illustrated in 32-pt. font, the caption text 126 is illustrated in 16-pt. font, and the normal text 128 is illustrated in 24-pt. font. As illustrated in FIG. 2A, this reduces the information density because the title and heading (title text 122 and text 124) now occupy close to the entirety of the display area and the normal text 128 is scrolled almost off-display. Thus, while the linear scaling makes the text larger, it interferes with reading the main content because of low information density.

FIG. 2B illustrates the application window 120 of FIG. 1A at a zoom level of 200% and a mid-range uniformity level, according to an implementation. Thus, for example, FIG. 2B illustrates the displayable content of application window 120 of FIG. 2A in response to the user setting the uniformity level to 50, e.g., by interacting with the contrast control 134, but leaving the zoom level of FIG. 2A unchanged (e.g., zoom level control 132 of FIG. 2A shows the same zoom level as the zoom level control 132 of FIG. 2B). Because the uniformity level has increased, the largest text, title text 122, has been scaled to 43.3-pt. font (instead of 48-pt. font in FIG. 2A) and the heading text 124 has been scaled to 30.9-pt. font (instead of 36-pt. font in FIG. 2A). Put another way, the uniformity level applies a smooth exponential decay to the zoom level for these fonts, causing them to scale more slowly than the normal text 128, which is still scaled to 24-pt. font. The caption text 126, which has a font size smaller than the normal text 128, becomes slightly larger because of the increased uniformity, e.g., increasing from 16-pt. in FIG. 2A to 16.6-pt. in FIG. 2B. FIG. 2B illustrates that because of the smaller scaling rate for the larger text in the displayable content, more of the normal text 128 is visible in the application window 120 when compared with linear scaling (e.g., illustrated in FIG. 2A).

FIG. 2C illustrates the application window of FIG. 1A at a zoom level of 200% and a maximum uniformity level (low contrast), according to an implementation. Thus, for example, FIG. 2C illustrates the displayable content of application window 120 of FIG. 2A in response to the user setting the uniformity level to 100, e.g., by interacting with the contrast control 134, but leaving the zoom level of FIG. 2A unchanged (e.g., zoom level control 132 of FIG. 2A shows the same zoom level as the zoom level control 132 of FIG. 2C). Because the uniformity level has increased to a range end value, the largest text, title text 122, has been scaled to 28.3-pt. font (instead of 48-pt. font in FIG. 2A) and the text 124 has been scaled to 25.6-pt. font (instead of 36-pt. font in FIG. 2A). As with FIG. 2B, the uniformity level applies the smooth exponential decay to the zoom level for these fonts, causing them to scale even more slowly than the normal text 128, which is still scaled to 24-pt. font. The caption text 126, becomes slightly larger again because of the increased uniformity, e.g., increasing from 16-pt. in FIG. 2A to 22.1-pt. in FIG. 2C. The scaling user interface 130 enables a user to adjust the zoom level and uniformity levels to balance the size of the text in the fixed font size (e.g., the normal text 128 of FIGS. 1A through 2C) with information density, enabling a user to increase the information density while still retaining the desired zoom level for the normal text 128. Although not illustrated in FIGS. 2A through 2C, the scaling user interface 130 may be scaling user interface 130′ of FIG. 2B, i.e., including a reset control 136 configured to, in response to selection, reset the uniformity level to the range start value (e.g., 10 in FIGS. 2A through 2C) and the zoom level to no zoom (e.g., 100%).

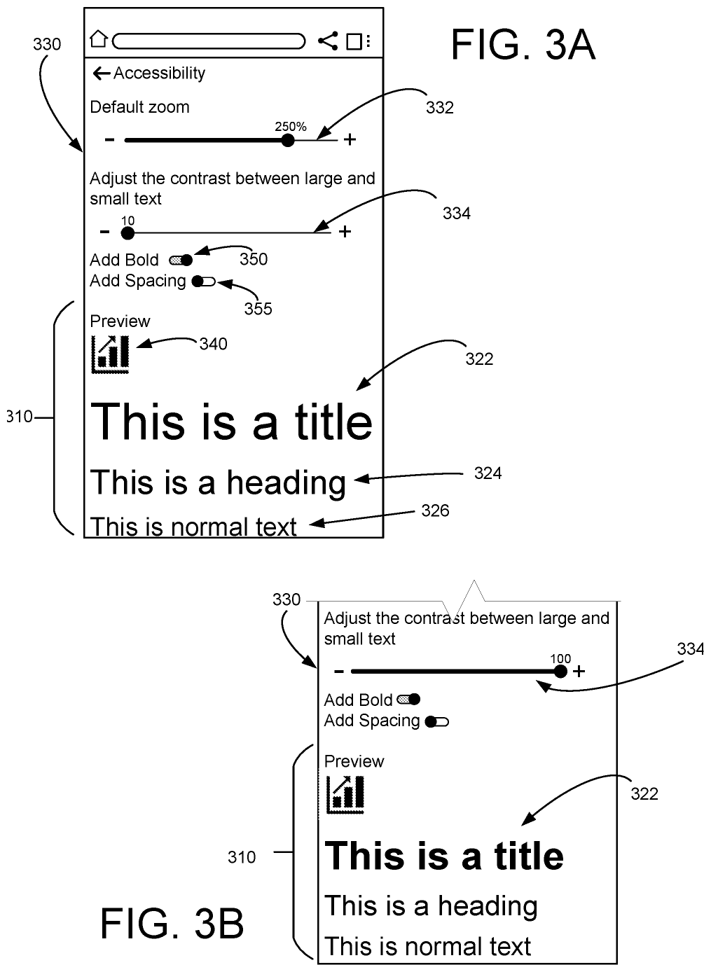

FIGS. 3A and 3B illustrate an example scaling user interface 330 for setting a uniformity level, according to an implementation. In the example of FIG. 3A, the user interface 330 may be used for setting uniformity level and/or zoom level at an application level (as an application setting for the scaling variable(s)) or a system level (as a system setting for the scaling variable(s)). In some implementations, the scaling variables, which include the zoom level and the uniformity level, can be applied in a hierarchical manner. In some implementations, a system scaling variable (a zoom level or uniformity level) may be applied to all content that can be scaled, but can be overwritten/trumped by an application setting or a page setting. In some implementations, an application setting (zoom level and/or uniformity level) can be overwritten/trumped by a page setting. Where the application is a browser, in some implementations, the user may be able to set domain scaling variables. Thus, for example, a domain may be associated with a zoom level and/or a uniformity level and the browser may provide a zoom level control and/or a contrast control for one or more domains. The domain settings may overwrite/trump system and browser settings, but can be overwritten by a page setting.

In some implementations, a level in the hierarchy may not track both scaling variables. Thus, for example, an implementation may allow for a system setting for the uniformity level but an application may only provide a zoom level control for the application. In such scenarios, the system setting of the uniformity level is used with the application zoom level in applying non-linear scaling to the content in the application. Similarly, a browser may have a zoom level and uniformity level (and a scaling user interface that enables a user to adjust these levels), but may only provide a zoom level control for tabs (page settings), using the browser uniformity level to apply non-linear scaling to content rendered in the tab using the tab zoom level. User interface elements configured to adjust the zoom level and/or uniformity level can be provided at any of these levels and do not need to be provided together. Thus, for example, the user interface 330 could include the contrast control 334 and not the zoom level control 332 because the zoom level is provided by a page setting (for example). Or the user interface 330 could include the zoom level control 332 and not the contrast control 334 because the uniformity level may be determined by a page setting.

In some implementations, a system zoom level can be multiplicative. In a multiplicative hierarchical configuration, a system zoom level may be considered a zoom default and any application or page zoom level may be applied to the zoom default. In such implementations, a zoom scalar can be used to determine linear or non-linear scaling. The zoom scalar is a difference between the zoom factor (e.g., at the page/application level) and the default zoom factor. For example, if the default zoom factor is 1.1 (e.g., the user has set a system-level zoom to 110%) and the user uses a zoom level control to adjust a page-level zoom to 200%, the zoom scalar would be 2.0*1.1, or 2.2. A uniformity level is not multiplicative.

The user interface 330 of FIG. 3A includes a zoom level control 332 and a contrast control 334, which are similar to zoom level control 132 and contrast control 134 of FIGS. 1A through 2C. The user interface 330 can also include a preview area 310. The preview area 310 includes sample displayable content so the user can evaluate the result of adjusting the zoom level via the zoom level control 332 and the uniformity level via the contrast control 334. Thus, for example, as the user increases the zoom level to 200% the system may scale the displayable content in the preview area 310. Similarly, as the user increases the uniformity level, the system may scale the displayable content in the preview area 310. The displayable content may include image content 340 and text content, including title text 322, heading text 324, and normal text 326. In some implementations, the image content, such as image content 340, does not scale with the text. In some implementations, the image content may scale linearly, like text of the fixed font size. In some implementations, the system may determine a font size equivalent to image dimensions and may use non-linear scaling on the image, e.g., changing an image height to the height of the font size equivalent, the horizontal dimension being scaled to preserve the image shape. In some implementations, although not illustrated in FIG. 3A, the user interface 330 can include a control that enables a user to turn on or turn off (toggle) scaling for images. Thus, for example, if scaling for images is off, images are not scaled and if a user uses the control to turn on scaling for images, scaling is applied to images (linear or nonlinear). Although not illustrated in FIG. 3A, the user interface 330 could include a reset control, similar to reset control 136 of FIG. 1B. The reset control, if included, would apply to the zoom level and/or uniformity level of FIG. 3A.

In addition, the user interface 330 of FIG. 3A includes a bold control 350. The bold control 350 may be configured to toggle on/off the use of bolding criteria. The bolding criteria may be configured to add visual differences back to text that does not scale significantly due to the uniformity level. In other words, the bolding criteria may represent conditions for adding additional visual differences to some of the text that has a default font size that is larger than the fixed font size. The bolding criteria can include text identified (e.g., via HTML or a stylesheet) as a header or title. The bolding criteria can identify text attributes assigned by markup language (e.g., HTML, a stylesheet, etc.). The bolding criteria can include determining whether text identified as a title or heading has a scaled font size that is within a threshold of the scaled font size of text having the fixed font size. The criteria can include the text having a ratio that meets a bold threshold. The ratio may be a ratio between a first value and a second value, where the first value represents a difference between the default font size (an initial size) of the text and the fixed font size, and the second value represents a difference between the scaled font size of the text (e.g., the current size, after non-linear scaling) and the scaled fixed font size. In other words, if the text has an original (default) font size of 24-pt and the fixed font size is 12-pt, and the text has a scaled font size of 32-pt and the fixed font size after scaling is 24-pt, the ratio would be 12/8 or 1.5. In an example, the bold threshold may be 1.3 or 1.25, etc.

If the use of bolding criteria is on, the system may be configured to determine whether any scaled text meets the bolding criteria and, if so, add the visual difference. The visual difference can be added via bolding, italicizing, underlining, highlighting, and/or a change in font color. Adding the visual difference can include any change, except for changing the font size, that helps the text stand out. FIG. 3B illustrates an example of bolding added to the title text 322 when the uniformity level is high.

In some implementations, the system may apply a smooth transition to bolding, or in other words, the system may gradually increase the boldness of font as the non-linear uniformity increases (low contrast level). Generally speaking fonts have “weights” between 100 and 900, with normal font being 400 and bold being 700. In some implementations, the system may apply a weight of 700 to text that meets the bolding criteria. In implementations with a smooth transition, the bolding criteria may be any text more than a predetermined percentage larger than the normal text, for example at a predetermined percentage of 100%, any text 24-pt. or larger if the fixed font size is 12-pt. would meet the bolding criteria. The system may assign the minimum uniformity level to the 400 font weight and the maximum uniformity level to the 700 font weight. In this example, if bolding is on and text meets the bolding criteria, and the uniformity level is the range end value (maximum uniformity level), the 700 weight is applied to the text. If the uniformity level is between the range start value and the range end value, a weight between 400 and 700 is applied to text that meets the bolding criteria. In some implementations, the weight can be stepped and weights divisible by 100 may be used. For example, uniformity level values falling in the first quartile of the uniformity level range (highest contrast) may have the 400 weight applied, uniformity level values falling in the second quartile of the uniformity level range may have a 500 weight applied, uniformity level values falling in the third quartile of the uniformity level range may have a 600 weight applied, and uniformity level values falling in the last quartile of the uniformity level range (lowest contrast) may have the 700 weight applied. Thus, the bolding may be a function of the uniformity level.

Implementations can include other ways to add visual differences, such as increasing word spacing, letter spacing, and/or line spacing in addition to, or instead of, the bolding. For example, the user interface 330 of FIG. 3A can include a spacing control 355. The spacing control 355 may be configured to toggle on/off the use of spacing criteria. In the example of FIG. 3A, the use of spacing criteria is off, but can be turned on by interaction with the spacing control 355. The spacing criteria can be similar to the bolding criteria, e.g., applying to text having a certain attribute specified by markup language, to text identified as a header/title, to text meeting a ratio, etc. In some implementations, the system may provide static values (e.g., tight, default, loose) that a user may choose for word, letter, and/or line spacing when the use of spacing criteria is on. In some implementations, the spacing may be based on the uniformity level or the zoom level. Thus, for example, increased word, line, and/or letter spacing can be based on the currently selected zoom level and uniformity level, e.g., tight when the uniformity level is low (e.g., bottom third, bottom quartile), loose when the uniformity level is high (e.g., top third, top quartile), etc.

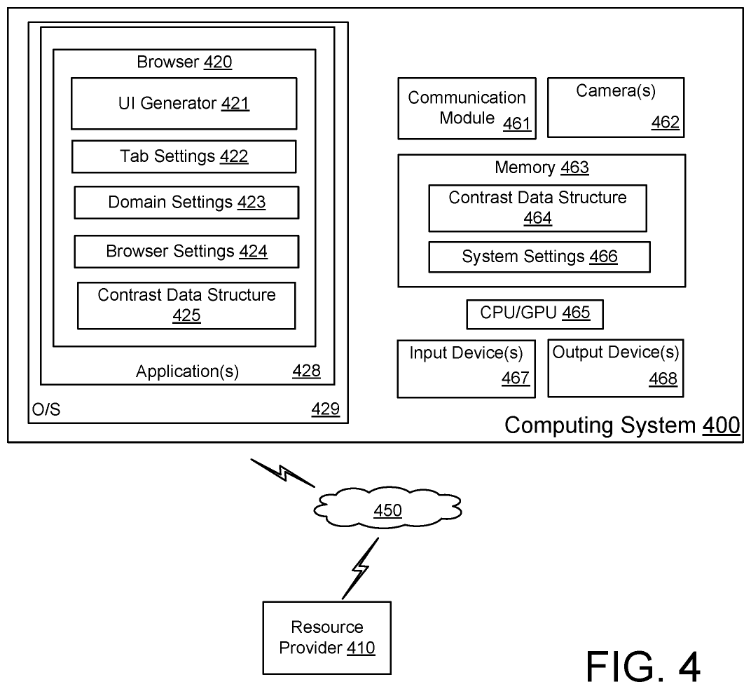

FIG. 4 is a diagram that illustrates a computing system 400 for implementing the concepts described herein. The computing system 400 can be a computing device with a limited screen size, such as a smartphone, a smart watch, smart (e.g., A/R or V/R) glasses, a tablet, an assistant with a display, etc. The computing system 400 can be a computing device with a larger screen size, such as a desktop computer, a laptop, a netbook, a notebook, a tablet, a smart TV, a game console with a browser, etc. In general, the computing system 400 can represent any computing device that executes an application that enables a user to adjust text size, e.g., enables a user to adjust the zoom level for content displayed by the application. As shown in FIG. 4, the computing system 400 may be configured to communicate with a resource provider 410 (e.g., a web server) via a network 450.

As shown in FIG. 4, the computing system 400 may include several hardware components including a communication module 461, one or more cameras 462, a memory 463, a processor 465, such as a central processing unit (CPU) and/or a graphics processing unit (GPU), one or more input devices 467 (e.g., touch screen, mouse, stylus, microphone, keyboard, etc.), and one or more output devices 468 (screen, speaker, vibrator, light emitter, etc.). The hardware components can be used to facilitate operation of applications 428 (including browser 420), an operating system (O/S) 429 and/or so forth of the computing system 400. The communication module 461 can be configured to facilitate communication with the resource provider 410 via the network 450 via one or more communication protocols. The camera 462 can be used for capturing one or more images, the memory 463 can be used for storing information associated with the browser 420, other applications 428, O/S 429, etc. The processor 465 can be used for processing information and/or images associated with the browser 420 and/or other applications 428. The computing system 400 also includes one or more output devices 468 such as communication ports, speakers, displays, and/or so forth.

In some implementations, the memory 463 may include system settings 466. System settings 466 may include variables used for various operating system functions and can include scaling variables. For example, the system settings 466 can include a system zoom level. The system settings 466 can include a uniformity level. In some implementations, the memory 463 may store a contrast data structure 464. The contrast data structure may be used to determine a minimum uniformity level (a range start value for the uniformity level). The contrast data structure 464 may be used in a scaling user interface to set the range start value of a contrast control, as explained in more detail with respect to FIG. 5. In some implementations, the contrast data structure may be stored in memory associated with an application of the applications 428, such as contrast data structure 425 for the browser 420.

The computing system 400 includes one or more applications 428 executed via the O/S 429. For ease in explanation, FIG. 4 illustrates the browser 420 as one example of an application. The browser 420 is used as an example of an application that allows for scaling of content, but the non-linear scaling techniques disclosed herein can be applied in other applications that include linear scaling functionality (a zoom) and/or can be incorporated in any application to implement scaling functionality. In some implementations, the browser 420 is configured to manage resource content, such as webpage content, provided by the resource provider 410 (e.g., a web server). The browser 420 can be configured to implement portions of the scaling user interface, windows, browser areas, and/or so forth, as described in connection with the implementations described herein.

The browser 420 includes a user interface (UI) generator 421 configured to generate and/or manage the various user interface elements of a browser such as the elements shown and described in FIGS. 1A through 3B. For example, the UI generator 421 can generate UI elements including the various elements in the application window 120, the scaling user interface 130, 130′, or 330 shown in at least FIGS. 1A, 1B, 2A through 2C, and/or FIGS. 3A and 3B. The UI generator 421 may include a rendering engine that generates and/or manages the displayable content in a browser tab, such as application window 120. The UI generator 421 may use a zoom level, a uniformity level, and a fixed font size to scale content in a page, e.g., in application window 120. The fixed font size can be static. A static font size may be set by the UI generator 421 and may not be changed by the user. In some such implementations, the fixed font size may be hard-coded. In some implementations, 12-pt. font may be the static fixed font size. The fixed font size can be user-determined. In some such implementations, the fixed font size may be a system variable, e.g., stored in the system settings 466 and the system may provide a user interface element configured to obtain a fixed font size from the user. The fixed font size can be selected from a most common font used in displayable content for an application window, e.g., for a web page displayed in application window 120. For example, the browser 420 may determine what font size is represented more than any other font size for the displayable content and set the fixed font size to that font size.

In some implementations, the browser 420 may be configured to provide a scaling user interface for a page, for a domain, and/or for the application. In implementations where the browser 420 provides a scaling interface for a page, the browser 420 may store the page zoom level and/or the page uniformity level in tab settings 422. In implementations where the browser 420 provides a scaling interface for a domain, the browser 420 may store the domain zoom level and/or the domain uniformity level in domain settings 423. In implementations where the browser 420 provides a scaling interface for the browser application, the browser 420 may store the browser zoom level and/or the browser uniformity level in the browser settings 424. As disclosed herein, a scaling interface may include a control for setting a zoom level, a control for setting a uniformity level, or both. If not supplied at any particular level, the zoom level or uniformity level can take a value from further up the hierarchy. For example, if a page scaling interface lacks a contrast control, the uniformity level for the application (application uniformity level) or for the system (system uniformity level) may be used. As discussed with respect to FIGS. 3A and 3B, the zoom levels and uniformity levels may be applied hierarchically. In some implementations, the zoom level may be multiplicative with a default zoom level (system zoom level).

The browser 420 may be configured to, amongst other things, provide/perform the actions associated with actionable controls, such as menu icon 114, zoom level control 132, contrast control 134, reset control 136, a back control, previous control, and/or next control. The browser 420 may be configured to cause performance of an action based on selection of a control, including causing performance of non-linear scaling in response to interaction with zoom level controls and/or uniformity level controls, as described herein.

FIG. 5 is a flowchart that illustrates an example method 500 for non-linear scaling of text, as described herein in the various figures. The method 500 can be implemented by at least the system shown in FIG. 4. In particular, the method 500 can be performed by an application that enables linear scaling of content, such as a browser, (e.g., browser 420) of a computing system 400. At step 502, the system may provide a scaling user interface for receiving/setting a zoom level and/or a uniformity level. In some implementations, providing the scaling user interface may include providing more than one scaling user interface. For example, the system may provide a system-level scaling user interface and a page-level scaling user interface, as described herein with respect to FIGS. 1A through 3B.

At step 504, the system adjusts font size(s) of text in displayable content using the zoom level, the uniformity level, and a fixed font size. As is understood, the displayable content may include text of different font sizes, and each font size represented is respectively adjusted. Thus, adjusting the font size of text can include adjusting each font size represented in the displayable content. Step 504 can replace an existing linear scaling process.

Adjusting the font size using the zoom level can include converting the zoom level to a zoom factor. The zoom factor is a decimal representation of the zoom level. Because a zoom level of 100% represents no scaling (e.g., fonts are displayed in their default font size), the zoom factor is one (1) for a zoom level of 100%. A zoom level of 50% has a zoom factor of 0.5, a zoom level of 150% has a zoom factor of 1.5, etc. The zoom factor may be used to determine (calculate) a zoom scalar, or in other words the zoom factor may be converted to a zoom scalar. The zoom scalar is a difference between the zoom factor and a default zoom factor. In implementations, the default zoom factor is fixed, e.g., at 1 (a zoom level of 100%). In some implementations that use an multiplicative hierarchical configuration, the default zoom factor may be a zoom level for a system setting or a zoom level for an application (e.g., a browser setting), depending on the implementation. For example, if the default zoom factor is 1.1 (e.g., the user has set a system-level or browser-level zoom to 110%) and the user uses a zoom level control to adjust a page zoom level to 200%, the zoom scalar would be 2.0 (the page zoom level)*1.1 (the default zoom level), or 2.2. A uniformity level is not multiplicative, but instead represents a decay rate applied. Adjusting the font size using the uniformity level can include determining which uniformity level (system setting, application setting, domain setting, page setting) to apply. Generally, the lowest level of the hierarchy with a contrast control is selected as the uniformity level (where page setting is the potential level and system setting is the highest potential level).

Adjusting the font size using the zoom level (converted to a zoom scalar), the uniformity level, and fixed font size may be accomplished using a nonlinear equation. The non-linear equation can be continuous and strictly monotonically increasing over text size. The non-linear equation can be continuous and monotonically increasing over zoom level. The non-linear equation may be configured to ensure that, as a result of the scaling, text initially of font size x will be, at every zoom level, larger than a second text initially of font size y, where x is larger than y. The non-linear equation may be configured to ensure that for a zoom level a that is larger than a zoom level b, text of some font size at zoom level a is at least as large or larger than the same text at zoom level b, but never smaller. A nonlinear equation F( ) can be used to set font size of various fonts at different zoom levels. An example non-linear equation F( ) that ensures both principles discussed above can be expressed as:

$$F ( z , t ) = \{ \begin{matrix}t ( ( z + 1 ) - ( \frac{z}{2} ) {e}^{- ( \frac{t - c}{λ} )} ) : if z \leq 0 \\ t ( 1 + {ze}^{- ( \frac{t - c}{λ} )} ) : if z > 0\end{matrix}$$

where z represents the zoom scalar (based on the zoom level), t represents the original (default) font size of the text being adjusted, λ represents the uniformity level (ranging between a range start value and a range end value) and c represents the fixed font size. As indicated above, c (the fixed font size) can be a static value, such as 12. In some implementations, the fixed font size can be determined from the content being displayed (e.g., set to the size of normal text or set to the size of the most common text in the content). As part of step 504, the non-linear equation may be applied to each original font size represented in the displayable content.

To ensure that text 2, which is originally larger than text 1, at every zoom level has a font size larger than text 1, is trivial for linear zoom equations, but there are values of λ (the uniformity level) in the non-linear equation for which this is false. To avoid text 2 from being assigned a font size smaller than text 1 at some zoom levels, implementations may use a minimum value (a range start value) for the uniformity level that ensures that text 2 is always larger than text 1. In some implementations, the minimum value can be based on the fixed font size, being set to a size slightly smaller than the fixed font size. For example, if the fixed font size is 12, the minimum value for the uniformity level can be set at 10. If the fixed font size is static, the minimum value for the uniformity level can be static. Where the fixed font size is not static, the system may include a data structure, e.g., contrast data structure 464 or contrast data structure 425 of FIG. 4, that maps minimum values to fixed font sizes.

In some implementations, the minimum value may be based on the zoom level. In such implementations, the system may include a data structure, such as contrast data structure 464 or contrast data structure 425 of FIG. 4, that maps minimum values to the zoom level. In some implementations, the data structure may be a function that maps the zoom level to a minimum value (range start value) for the uniformity level. In some implementations, the function may be represented as a series of rules:

$${λ}_{min} ( z ) = \{ \begin{matrix}17.314 : if z \leq 0. \\ 3.4 z + 2.8 : if z \leq 0.5 \\ 3.5 z + 2.75 : if z \leq 2.9 \\ \frac{67}{11} z - \frac{262}{55} : if z \leq 4. \\ \frac{97}{9} z - \frac{1058}{45} : if z \leq 4. \\ 21 z - 73.6 : if z \leq 5.6\end{matrix}$$

The example series of rules above, which may be part of a data structure that maps zoom levels to range start values for the uniformity level, work for zoom levels up to 660%, which is typical for many computing devices. In some implementations, a golden section search may be used to determine the rules for the data structure.

As part of adjusting the font size using the zoom level (converted to a zoom scalar), the uniformity level, and fixed font size, step 504 may include determining whether a particular font size meets bolding criteria. The bolding criteria can be a criterion or combination of criterion. The bolding criteria can be configured to add visual differences back to text that does not scale much due to the uniformity level. In other words, the bolding criteria may represent conditions for adding additional visual differences to some of the text that has a default (original/initial) font size that is larger than the fixed font size but is now (after non-linear scaling is applied) not much larger than the text of the fixed font size. The bolding criteria can include text being identified (e.g., via HTML or a stylesheet) as a header or title. The bolding criteria can include determining whether text identified as a title or heading has a scaled font size that is within a threshold of the scaled font size of the normal text (text having a font size equal to the fixed font size). The criteria can include the text having a ratio that meets a bold threshold. If bolding is turned on (e.g., via bold control 350 of FIG. 3A), step 504 can include applying the visual difference (bolding, highlighting, italicizing, changing the font color) to the text. Step 504 can be performed in place of a linear scaling routine.

At step 506, the system initiates display of the content, with the adjusted font sizes. Steps 504 and/or 506 can be repeated, e.g., by a rendering process, as needed to display the content in accordance with the zoom level and uniformity level selected by the user. Steps 504 and 506 may thus be incorporated into an application or system scaling process that currently performs linear scaling on content.

Returning to FIG. 4, the computing system 400 may include other components, not illustrated, such as a high-speed controller connecting the memory 463 and high-speed expansion ports, a low-speed controller connecting the memory 463 to low speed expansion ports, etc. The processor 465 can be a semiconductor-based processor. The processor 465 may be implemented as a chipset of chips that include separate and multiple analog and digital processors. The processor 465 may provide, for example, for coordination of the other components of the computing system 400. The memory 463 can be a semiconductor-based memory. Each of the components can be interconnected using various busses, and may be mounted on a common motherboard or in other manners as appropriate. The processor 465 can process instructions for execution within the computing system 400, including instructions stored in the memory 463 to display graphical information for a GUI on an external input/output device, such as a display of output devices 468 coupled to a high-speed controller. In other implementations, multiple processors and/or multiple buses may be used, as appropriate, along with multiple memories and types of memory.

The memory 463 stores information within the computing system 400. In one implementation, the memory 463 is a volatile memory unit or units. In another implementation, the memory 463 is a non-volatile memory unit or units. The memory 463 may also be another form of computer-readable medium, such as a magnetic or optical disk.

The computing system 400 may include a storage device is capable of providing mass storage for the computing system 400. In one implementation, the storage device may be or contain a computer-readable medium, such as a removable memory device, a hard disk device, an optical disk device, a flash memory or other similar solid state memory device, or an array of devices, including devices in a storage area network or other configurations. A computer program product can be tangibly embodied in a storage medium. The computer program product may also contain instructions that, when executed, perform one or more methods, such as those described above. The storage medium is a computer- or machine-readable medium, such as the memory 463, the storage device, or memory on processor 465, or memory storing the O/S 429 and/or applications 428.

The computing system 400 may include a high-speed controller that manages bandwidth-intensive operations for the computing system 400, such as communications with a display. Similarly, a low-speed controller may manage lower bandwidth-intensive operations. Such allocation of functions is an example only. In the implementation, a low-speed controller is coupled to a storage device and a low speed expansion port. The low-speed expansion port, which may include various communication ports (e.g., USB, BLUETOOTH, Ethernet, wireless Ethernet) may be coupled to one or more input devices 467 and/or output devices 468, such as a keyboard, a pointing device, a scanner, or a networking device such as a switch or router, e.g., through a network adapter.

The display may be an input device 467, for example, that includes a TFT LCD (Thin-Film-Transistor Liquid Crystal Display) or an OLED (Organic Light Emitting Diode) display, or other appropriate display technology. The computing system 400 may include a display interface that comprises appropriate circuitry for driving the display to present graphical and other information to a user. The control interface may receive commands from a user and convert them for submission to the processor 465. The computing system 400 may include an external interface that can provide, for example, for wired communication in some implementations, or for wireless communication in other implementations, and multiple interfaces may also be used.

The computing system 400 may communicate wirelessly through communication module 461, which may include digital signal processing circuitry where necessary. Communication module 461 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a transceiver. In addition, short-range communication may occur, such as using a BLUETOOTH, WI-FI, or other such transceiver. In addition, the computing system 400 may include a GPS (Global Positioning System) receiver module that may provide additional navigation- and location-related wireless data to the computing system 400, which may be used as appropriate by applications running on the computing system 400.

Computing system 400 may also communicate audibly using an audio codec, which may receive spoken information from a user and convert it to usable digital information (e.g., speech-to-text). The audio codec may likewise generate audible sound for a user, such as through a speaker, e.g., of output devices 468. Such sound may include sound from voice telephone calls, may include recorded sound (e.g., voice messages, music files, etc.) and may also include sound generated by applications operating on computing system 400.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube), OLED, TFT, or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made without departing from the spirit and scope of the disclosed implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

Clause 1. A method comprising: using a fixed font size, a zoom level, and a uniformity level to adjust text size of text in displayable content; and initiating display of the content.

Clause 2. The method of clause 1, wherein the uniformity level causes non-linear scaling of the text relative to the fixed font size.

Clause 3. The method of clause 1, wherein the uniformity level represents a smooth exponential decay that controls how quickly text with fonts larger than and smaller than the fixed font size scale in relation to the fixed font size.

Clause 4. The method of any one of clause 1 to clause 3, further comprising: providing a user interface element for receiving the uniformity level, wherein the user interface element is configured to set the uniformity level to a value between a range start value and a range end value, the range start value being dependent on the fixed font size or on a zoom scalar calculated from the zoom level.

Clause 5. The method of clause 4, further comprising: storing a data structure that maps fixed font sizes to range start values.

Clause 6. The method of clause 4, further comprising: storing a data structure that maps zoom levels to range start values, wherein the range start value is determined using the zoom level.

Clause 7. The method of any one of clause 4 to clause 6, wherein the user interface element is a first user interface element provided in a user interface, the user interface including a second user interface element for receiving the zoom level.

Clause 8. The method of clause 7, wherein the user interface includes a reset control and the method further includes: receiving selection of the reset control; and responsive to receiving the selection, setting the uniformity level to the range start value and setting the zoom level to a default zoom level.

Clause 9. The method of any one of clause 1 to clause 8, wherein adjusting the text size of the text in the displayable content further includes: determining that a portion of text of the text in the displayable content meets bolding criteria; and in response to the determining, adding a visual difference to the portion of text as part of adjusting the text size of text in the displayable content.

Clause 10. The method of clause 9, wherein the bolding criteria identifies text attributes assigned in markup language.

Clause 11. The method of clause 9, wherein the bolding criteria includes a ratio between a first value and a second value meeting a bold threshold, the first value representing a difference between an initial size of the portion of text and the fixed font size and the second value representing a difference between a current size of the portion of text and the fixed font size.

Clause 12. The method of any one of clause 1 to clause 11, wherein using the zoom level and the uniformity level to adjust the text size includes converting the zoom level to a zoom factor and using the zoom factor to determine a zoom scalar, the zoom scalar representing a difference between the zoom factor and a default zoom factor.

Clause 13. The method of any one of clause 1 to clause 12, wherein the fixed font size is one of a selected font size, a normal font size represented in the displayable content, and a static font size.

Clause 14. The method of anyone of clause 1 to clause 13, wherein the zoom level is a page zoom level or an application zoom level, and the uniformity level is a page uniformity level or an application uniformity level.

Clause 15. method of any one of clause 1 to clause 14, wherein using the zoom level and the uniformity level to adjust the text size of text in the displayable content includes: ensuring that a size of first text in the displayable content, which is initially larger than second text in the displayable content, is larger than the size of the second text; and ensuring that a size of text at a first zoom level is not smaller than a size of the text at a second zoom level when the second zoom level is larger than the first zoom level.

Clause 16. A method comprising: initiating display of a scaling user interface that includes: a zoom level control for obtaining a zoom level, a uniformity level control for obtaining a uniformity level, and a preview area, the preview area including text of a first font size and text of a second font size; receiving a change to the zoom level or the uniformity level; and in response to receiving the change, updating a display of the preview area by applying non-linear scaling of the text of the first font size and the text of the second font size based on the zoom level, the uniformity level, and the first font size.

Clause 17. The method of clause 16, wherein the scaling user interface includes a reset control and the method further includes: receiving selection of the reset control; and in response to receiving the selection, setting the zoom level to 100% and setting the uniformity level to a range start value.

Clause 18. The method of any one of clause 16 to clause 17, wherein the scaling user interface includes a bold control and the operations further include: receiving selection of the bold control to turn on use of bolding criteria, wherein updating the display of the preview area includes: determining whether the text of the second font size meets the bolding criteria, and in response to determining that the text of the second font size meets the bolding criteria, adding a visual difference to the text of the second font size.

Clause 19. The method of any one of clause 16 to clause 18, wherein the scaling user interface includes a spacing control and the method further includes: receiving selection of the spacing control to turn on use of spacing criteria, wherein updating the display of the preview area includes: determining whether the text of the second font size meets the spacing criteria, and in response to determining that the text of the second font size meets the spacing criteria, changing spacing of the text of the second font size.

Clause 20. A computing device comprising: at least one processor; and a memory storing instructions that, when executed by the at least one processor, cause the computing device to perform the method of any of clause 1 to clause 19.

In some aspects, the techniques described herein relate to a system, including at least one processor; and memory storing instructions that, when executed by the at least one processor, causes the system to perform any of the methods or processes disclosed herein.

In some aspects, the techniques described herein relate to a non-transitory computer-readable medium storing instructions, that when executed by a processor, cause a computing system to perform any of the methods or processes disclosed herein.

In some aspects, the techniques described herein relate to a system including a means for receiving a uniformity level, a means for reeving a zoom level, and a means for adjusting the font size(s) of text in displayable content using the zoom level, the uniformity level, and a fixed font size. The system may also include a means for displaying the content with the adjusted font size(s). In some implementations, the system may also include a means for determining a range start value for the uniformity level. The means for receiving the uniformity level may use the range start value and a range end value for restricting settings of the uniformity level.

What is claimed is:

1. A computer-readable medium storing instructions that when executed by at least one processor cause the at least one processor to execute operations, the operations comprising:
using a fixed font size, a zoom level, and a uniformity level to adjust text size of text in displayable content; and
initiating display of the content.

2. The computer-readable medium of claim 1, wherein the uniformity level causes non-linear scaling of the text relative to the fixed font size.

3. The computer-readable medium of claim 1, wherein the uniformity level represents a smooth exponential decay that controls how quickly text with fonts larger than and smaller than the fixed font size scale in relation to the fixed font size.

4. The computer-readable medium of claim 1, the operations further comprising:
providing a user interface element for receiving the uniformity level,
wherein the user interface element is configured to set the uniformity level to a value between a range start value and a range end value, the range start value being dependent on the fixed font size or on a zoom scalar calculated from the zoom level.

5. The computer-readable medium of claim 4, further storing a data structure that maps fixed font sizes to range start values.

6. The computer-readable medium of claim 4, further storing a data structure that maps zoom levels to range start values, wherein the range start value is determined using the zoom level.

7. The computer-readable medium of claim 4, wherein the user interface element is a first user interface element provided in a user interface, the user interface including a second user interface element for receiving the zoom level.

8. The computer-readable medium of claim 7, wherein the user interface includes a reset control and the operations further include:
receiving selection of the reset control; and
responsive to receiving the selection, setting the uniformity level to the range start value and setting the zoom level to a default zoom level.

9. The computer-readable medium of claim 1, wherein adjusting the text size of the text in the displayable content further includes:
determining that a portion of text of the text in the displayable content meets bolding criteria; and
in response to the determining, adding a visual difference to the portion of text as part of adjusting the text size of text in the displayable content.

10. The computer-readable medium of claim 9, wherein the bolding criteria identifies text attributes assigned in markup language.

11. The computer-readable medium of claim 9, wherein the bolding criteria includes a ratio between a first value and a second value meeting a bold threshold, the first value representing a difference between an initial size of the portion of text and the fixed font size and the second value representing a difference between a current size of the portion of text and the fixed font size.

12. The computer-readable medium of claim 1, wherein using the zoom level and the uniformity level to adjust the text size includes converting the zoom level to a zoom factor and using the zoom factor to determine a zoom scalar, the zoom scalar representing a difference between the zoom factor and a default zoom factor.

13. The computer-readable medium of claim 1, wherein the fixed font size is one of a selected font size, a normal font size represented in the displayable content, and a static font size.

14. The computer-readable medium of claim 1, wherein the zoom level is a page zoom level or an application zoom level, and the uniformity level is a page uniformity level or an application uniformity level.

15. The computer-readable medium of claim 1, wherein using the zoom level and the uniformity level to adjust the text size of text in the displayable content includes:
ensuring that a size of first text in the displayable content, which is initially larger than second text in the displayable content, is larger than the size of the second text; and
ensuring that a size of text at a first zoom level is not smaller than a size of the text at a second zoom level when the second zoom level is larger than the first zoom level.

16. A computer-readable medium storing instructions that when executed by at least one processor cause the at least one processor to execute operations, the operations comprising:
initiating display of a scaling user interface that includes:
a zoom level control for obtaining a zoom level,
a uniformity level control for obtaining a uniformity level, and
a preview area, the preview area including text of a first font size and text of a second font size;
receiving a change to the zoom level or the uniformity level; and
in response to receiving the change, updating a display of the preview area by applying non-linear scaling of the text of the first font size and the text of the second font size based on the zoom level, the uniformity level, and the first font size.

17. The computer-readable medium of claim 16, wherein the scaling user interface includes a reset control and the operations further include:
receiving selection of the reset control; and
in response to receiving the selection, setting the zoom level to 100% and setting the uniformity level to a range start value.

18. The computer-readable medium of claim 16, wherein the scaling user interface includes a bold control and the operations further include:
receiving selection of the bold control to turn on use of bolding criteria,
wherein updating the display of the preview area includes:
determining whether the text of the second font size meets the bolding criteria, and
in response to determining that the text of the second font size meets the bolding criteria, adding a visual difference to the text of the second font size.

19. The computer-readable medium of claim 16, wherein the scaling user interface includes a spacing control and the operations further include:
receiving selection of the spacing control to turn on use of spacing criteria,
wherein updating the display of the preview area includes:
determining whether the text of the second font size meets the spacing criteria, and
in response to determining that the text of the second font size meets the spacing criteria, changing spacing of the text of the second font size.

20. A method comprising:
using a fixed font size, a zoom level, and a uniformity level to adjust text size of text in displayable content, and
initiating display of the content.

21. The method of claim 20, wherein the uniformity level causes non-linear scaling of the text relative to the fixed font size.

22. The method of claim 20, the operations further comprising:
receiving, from a first user interface element, the uniformity level; and
receiving, from a second user interface element, the zoom level,
wherein the first user interface element is configured to set the uniformity level to a value between a range start value and a range end value, the range start value being dependent on the fixed font size or on a zoom scalar calculated from the zoom level.

23. The method of claim 22, wherein operations further include:
receiving a selection of a reset control; and
responsive to receiving the selection, setting the uniformity level to the range start value and setting the zoom level to a default zoom level.

24. The method of claim 20, wherein adjusting the text size of the text in the displayable content further includes:
determining that a portion of text of the text in the displayable content meets bolding criteria; and
in response to the determining, adding a visual difference to the portion of text as part of adjusting the text size of text in the displayable content.

25. The method of claim 20, wherein the zoom level is a page zoom level or an application zoom level, and the uniformity level is a page uniformity level or an application uniformity level.
